(19) United States
(12) Patent Application Publication
(10) Pub. No.: US 2004/0260657 A1
(43) Pub. Date: Dec. 23, 2004

(54) System and method for user-controlled on-line transactions

(76) Inventor: John Cockerham, Hollywood, FL (US)

Correspondence Address: ROBERTS ABOKHAIR & MARDULA, SUITE 1000, 11800 SUNRISE VALLEY DRIVE, RESTON, VA, 20191, US

(21) Appl. No.: 10/782,630

(22) Filed: Feb. 19, 2004

Related U.S. Application Data
(63) Continuation-in-part of application No. 09/659,224, filed on Sep. 11, 2000, now abandoned.
(60) Provisional application No. 60/219,213, filed on Jul. 18, 2000.

(51) Int. Cl. G06F 17/60

(52) U.S. Cl. 705/76

(57) ABSTRACT

The present invention is a system and method for user-controlled on-line transactions. A user computer sends a request to purchase to a merchant computer. The merchant computer sends transaction data and an identifier indicative of an authentication methodology to the user computer and a clearinghouse computer. The purchaser proffers his or her biometric identifier to the user computer. If proffered biometric identifier matches a biometric identifier stored only on the user computer, the user computer sends an authentication dataset of purchaser identifying information associated with the authentication identifier and transaction information to the clearinghouse computer. The clearinghouse computer applies the authentication methodology associated with the authentication identifier to the authentication dataset of purchaser identifying information received from the user computer and to an authentication dataset of purchaser identifying information stored on the clearinghouse computer to authenticate the purchaser. If the purchaser is authenticated, the transaction is authorized by the clearinghouse without any purchaser registration data being provided to the merchant.

### CROSS REFERENCE TO RELATED APPLICATIONS

This application is a continuation in part of application Ser. No. 09/659,224 filed Sep. 11, 2000, which claimed priority from provisional application No. 60/219,213 filed Jul. 18, 2000. Both applications are incorporated by reference herein, in their entirety, for all purposes.

### BACKGROUND

This invention relates generally to purchasing of goods and services and other transactions via on-line transactions. More particularly, the present invention is a system and method of making purchases on-line with enhanced security for purchaser information.

Information transmitted over a computer network, including information relating to purchasing, can be easily accessed by many parties besides the intended recipient. For this reason, several methods of protecting the security of information transmitted over a network have been developed. Among them are Public/Private Key systems, symmetric key systems, and other security means. However, one of the problems associated with symmetric key systems is that the parties to the exchange must securely exchange the key. The exchange and usage of mathematically complex encryption means is not practical for on-line transactions.

As part of any transaction on-line, credit card clearinghouses verify that the buyer has proper credit to pay the seller. Without the verification, the seller would not enter the transaction because he has no assurance that he will get paid. When transactions are conducted on-line, the buyer, seller, and clearinghouse all must participate in the exchange of information. The problem with such transactions is that the buyer's personal financial information is transmitted over a network and potentially accessible to unauthorized parties. Though encryption methods are used to protect the user, they are primarily under merchant control. As a consequence, the merchant dictates the information required from a consumer to consummate a transaction. If the consumer desires to use the system adopted by the merchant, the consumer must make the information required by the system available to the merchant.

One known system that utilizes merchant control architecture is described in U.S. Pat. No. 6,092,053 to Boesch, et al. for a system and method of merchant invoked electronic commerce. This patent discloses a system where the consumer's transaction information is stored on a Consumer Information Server. To complete a purchase transaction, the merchant collects purchase information about the consumer from the Consumer Information Server. The consumer has no approval or disclosure control once the transaction is submitted. Further, this system does not provide the consumer with a method of approving transactions of a named user of the account.

An on-line transaction service using biometric identifiers is provided by CHECKagain, Inc. of Herndon, Va. The CHECKagain system allows a user to authenticate or approve on-line transactions using a biometric identifier. A user first registers his transaction information and registration information for all authorized users with the CHECKagain server. The user must register at a CHECKagain facility or kiosk. If the user or another user of the account makes a transaction, the user can approve the transaction by submitting his biometric identifier to the CHECKagain server. For the approval to take place, the biometric identifier information is transmitted over a network and compared to the biometric identifier on file for matching results. Thus, the user's identifying and personal information is transmitted over the network. As a result, the user's confidential information is not within the user's control and is subject to the vagaries of Internet transmission.

In U.S. Pat. No. 5,862,223 issued to Walker et al. for a Method And Apparatus For A Cryptographically-Assisted Commercial Network System Designed To Facilitate And Support Expert-Based Commerce, a secure transaction scheme using bio-identification coupled with public-key cryptography for encryption and digital signatures is described. All public keys are signed by a certification authority. Certificates can be sent with messages and different keys can be used for encryption and digital signatures. The trusted third party knows everyone's public key and everyone knows the third party's public key. While arguably secure, this reliance on mathematically complex encryption techniques and the requirement for a central authority imposes a complex mathematical and associated processing overhead on on-line transactions. Further, the system described by Walker assumes that the user (analogous to the purchaser in an on-line payment system) is untrustworthy. Thus, Walker is directed to protecting the seller more than the buyer.

Walker acknowledges that cryptographic techniques can provide greater confidence in the authenticity of an individual but are useless if the cryptographic keys are compromised:

An attacker obtaining the symmetric key of another expert is indistinguishable from that expert in the eyes of central controller 200. There is no way to know whether the expert was the true author of expert answer 130, or an attacker with the right cryptographic keys. The only way to solve this problem (known as undetected substitution) is to use biometric devices such as a fingerprint reader, voice recognition system, retinal scanner and the like. These devices incorporate a physical attribute of the expert into his expert answer 130, which is then compared with the value stored in expert database 255 at central controller 200. In the present invention, such devices attach to expert interface 400. Walker, Col. 32, lines 27-43). Walker teaches that a central authority is trustworthier than users. In order to practice Walker, a user is compelled to entrust the central authority with the user's biometric identifier, the means Walker asserts is the “only way to solve this problem.”

In U.S. Patent Application 20020073046 to David for A System And Method For Secure Network Purchasing, the problem of providing personal information to a merchant is addressed by exploiting the relationship between a user and his or her Internet Service Provider (ISP). A user computer signs in to the ISP computer system and is recognized and assigned an IP address. When the user identifies merchandise or services at a vendor's website which he wishes to purchase, he sends programming to the website which selects the items and instructs the vendor's computer to generate a purchase authorization request which is sent to the ISP computer. The purchase authorization request contains information about the merchandise to be purchased, identifying information about the proposed purchaser, some of which is the identifying information assigned by the ISP to the user. The ISP computer confirms internally that the user is still signed in to the ISP computer system by verifying the identity of the computer currently actively communicating through the IP address. When satisfied that the user is still on-line, the ISP computer generates and sends a message to the user's computer requesting confirmation of the order for the merchandise. Confirmation is accomplished by the user entering a password. Upon receipt from the user's computer of the confirmation, the ISP generates and transmits to the vendor's computer a message confirming the order and providing a confirmation number, agreeing to pay the invoice which the vendor's computer subsequently generates and presents to the ISP computer. The ISP computer then uses the user's credit card information and presents an invoice against the credit card account to be sent through normal channels.

David teaches an exchange of messages between an ISP and a merchant and confirmation of a purchase by a user. While the user information is not directly provided to the merchant, the user is not in control of the transaction. This is due, in part, because David teaches the authentication of the user computer, determined via IP address sniffing, that is separate from the authentication of the user, who is authenticated via a password entered by the user in a user confirmation message. The security of the transaction thus depends on the security of the entity that is confirming the password information. David does not teach, and would teach against, adding a mechanism for authenticating the user at the user computer. In David, and ISP is entrusted not only with the financial data of a user but also with the user's identifying information.

Current systems for on-line purchasing put control of personal information and privacy with the merchant or, as in David, a third party to a transaction. Since the merchant or third party controls the transaction format, the merchant also has control of the customer's personal information. Thus the user is not in control of protecting himself or his private information.

What is needed is a system and method of secure purchasing over a network that does not require the user to send to the merchant personal identifying information of the user or to send personal identifying information over the network as part of the purchase transaction. Such a system and method would authenticate the user using a method selected at a user computer and would achieve a high level of security without the overhead of complex mathematical encryption algorithms and without disclosing the biometric identifier of a user to a third party.

### SUMMARY

Embodiments of the present invention are directed to user initiated systems and methods useful for conducting financial or purchase transactions (collectively “transactions”) on-line in a secure fashion.

It is therefore an aspect of the present invention to provide a system and method of secure financial data transfer.

It is a further aspect of the present invention to allow a user to control the amount of personal information transmitted over the Internet.

It is another aspect of the present invention to separate the locations of where user identification and transaction validation are performed.

It is yet another aspect of the present invention to allow a method of authentication to be used by a clearinghouse computer to be determined by a user's computer.

It is a further aspect of the present invention to allow a user to authorize a transaction by presenting a biometric identifier to a user computer for identification at the user computer.

It is still another aspect of the present invention to allow a user who has authorized a transaction using a biometric identifier to continue to shop without waiting for a response or a prompt from a clearinghouse computer or a merchant.

It is another aspect of the present invention to protect the privacy of the user bio-identification information by maintaining the user biometric identifier at the user computer under control of the user at all times.

It is still another aspect of the present invention to allow a customer to provide transaction identification data at a user computer versus at a remote server.

It is still another aspect of the present invention to authorize a transaction between a purchaser and a merchant without providing credit card information of the purchaser to the merchant.

It is still another aspect of the present invention to relieve the merchant of primary responsibility for maintaining on-line transaction security.

It is another aspect of the present invention to identify merchants using the systems and methods of the present invention so as to engender confidence of consumers in the veracity of such merchants.

It is yet another aspect of the present invention to prevent unauthorized users of a credit card to complete a transaction.

It is another aspect of the present invention to simplify the information requirements of a transaction system and to reduce the time needed to consummate an on-line transaction.

It is a further aspect of the present invention to minimize the data needed to complete a transaction.

It is still another aspect of the present invention to make transaction data meaningless to an interceptor.

Embodiments of the present invention provide user controlled systems and methods useful for conducting financial or purchase transactions (collectively “transactions”) on-line in a secure fashion. In an exemplary embodiment of the present invention, a merchant computer, a user computer, and a clearinghouse computer are connected to a network that is preferably, but without limitation, the Internet. Other networks used for purchase transactions are also suitable for the present invention. A user pre-registers with the clearinghouse computer, thereby providing the clearinghouse computer with transaction information and one or more authentication datasets comprising personal identifying information. However, the user's biometric information is never conveyed to the clearinghouse computer or the merchant computer. The user also registers with user software installed on a user computer. During the user registration with the user software, transaction information and the one or more authentication datasets comprising personal identifying information of the user is stored on the user computer. The transaction information and authentication datasets of personal identifying information are associated with a biometric identifier (e.g., a fingerprint, voiceprint, retinal scan, or other such identifier) supplied by the user. Subsequent access to the transaction information and user personal identifying information requires presentment of the biometric identifier associated with that information.

A merchant also registers with the clearinghouse computer by providing account and identifying information.

The user purchases items from the merchant with the transaction being processed through a clearinghouse. In an embodiment of the present invention, the clearinghouse is connected to a credit card processor. In another embodiment of the present invention, a credit card processor performs the clearinghouse functions.

Both the user software installed on the user's computer and the clearinghouse software installed on the clearinghouse computer have a number of pre-stored authentication methodologies. Each authentication methodology requires a unique set of personal identifying information to authenticate the user so that a transaction may be processed. According to embodiments of the present invention, a unique set of personal identifying information comprises data elements that have no intrinsic value to a third party (other than the clearinghouse) should the personal identifying information be intercepted. By way of illustration and not as a limitation, a first authentication methodology uses a first authentication dataset comprising the user's first name, a street address, a first key word and the last four digits of a bank account number. A second authentication methodology uses a second authentication dataset comprising the user's last name, a street address, a second key work, and the last four digits of a credit card number. Any number of authentication datasets (each representing an authentication methodology) may be established without departing from the scope of the present invention. Each authentication methodology is identified by a unique authentication ID. Both the user computer and the clearinghouse computer must “know” which authentication methodology is being used so that the requisite authentication dataset of personal identifying information can be delivered by the user computer and confirmed by the clearinghouse computer. A process by which this is accomplished is described below.

In response to a purchase request from a user, a merchant computer generates a purchase receipt, a bookmark index and a transaction number and conveys these data to a user computer. The merchant also conveys the bookmark index, the transaction number and, optionally, the purchase receipt, to a clearinghouse computer. The user issues a purchase authorization by presenting the user's biometric identifier to the user computer. The presentment of the user's biometric identifier causes the user computer to generate a sequence string and to select an authentication identifier representing one of the available authentication datasets. The authentication identifier is inserted into the sequence string at a location determined by the bookmark index. The user's computer then sends the transaction number, the purchase receipt, the sequence string, and the authentication dataset represented by the authentication identifier to the clearinghouse computer.

The clearinghouse computer uses the bookmark index received from the merchant to locate the authentication identifier in the sequence string. The clearinghouse computer associates an authentication methodology with the authentication identifier. The clearinghouse computer then applies the authentication methodology to compare the authentication dataset sent by the user computer to the personal identifying information provided to the clearinghouse computer by the user during registration. If the user is authenticated and if the user has sufficient credit available, the clearinghouse computer so notifies the merchant computer by sending a message to the merchant identifying to the merchant the transaction that is authorized via the transaction number. A data transaction monitor tracks and pays the payment service for each approved transaction placed by a registered user. The clearinghouse computer then uses the user's transaction information to complete the transaction.

### DESCRIPTION OF THE DRAWINGS

FIG. 1 illustrates an exemplary architecture of a transaction system according to embodiments of the present invention.

FIG. 2 illustrates a format of a sequence string according to embodiments of the present invention.

FIGS. 3A, 3B and 3C illustrate a method for purchasing goods via a network according to embodiments of the present invention.

### DETAILED DESCRIPTION

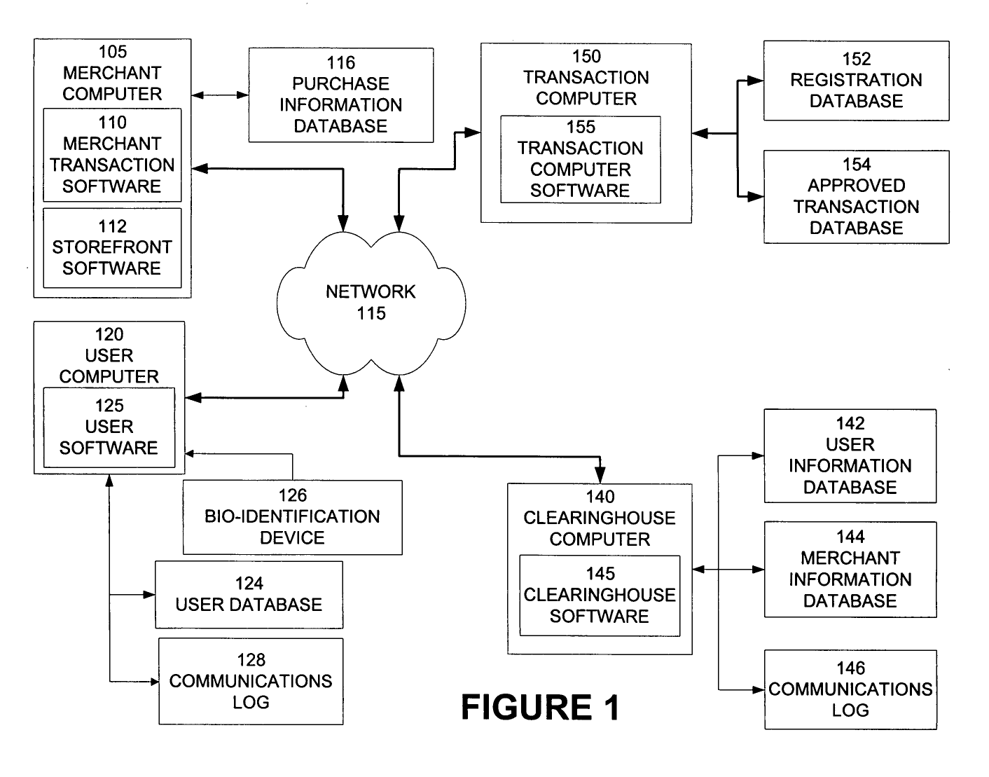

Embodiments of the present invention provide user controlled systems and methods useful for conducting financial or purchase transactions (collectively “transactions”) on-line in a secure fashion. FIG. 1 illustrates an exemplary architecture of a transaction system according to embodiments of the present invention. Referring to FIG. 1, a merchant computer 105, a user computer 120, a clearinghouse computer 140, and a data transaction computer 150 are connected to a network 115. In this embodiment, merchant computer 105, user computer 120, clearinghouse computer 140, and data transaction computer 150 are general-purpose computers having a processor and memory. However, the invention is not so limited. Any device capable of sending and receiving a message over a network may be used to practice the invention. By way of illustration and not as a limitation, user computer 120 may be a personal data assistant, a lap top computer, a cell phone, or any other device by which means for transmitting the required information may be accomplished. Additionally, computers 105, 120, 140, and 150, have Internet access capability. Modem, fiber, wireless or any other network connection known in the art can support the architecture of the present invention. The network 115 is preferably the Internet although this is not meant as a limitation. Other private and public networks are also suitable for transactions of the present invention. As will be apparent to those skilled in the art, the functions of the clearinghouse computer and the data transaction computer may be performed on a single device without departing from the scope of the present invention.

The merchant computer 105 comprises merchant transaction software 110 and storefront software 112. User computer 120 comprises user software 125. The clearinghouse computer 140 comprises clearinghouse software 145. The data transaction computer 150 comprises data transaction software 155.

According to embodiments of the present invention, the merchant (not illustrated in FIG. 1) registers with the clearinghouse operator (not illustrated in FIG. 1) by providing identifying information and account information. Any means may be used to establish a relationship between the merchant and the clearinghouse operator without departing from the scope of the present invention.

The storefront software 112 provides a merchant the necessary tools to conduct on-line sales and is well known in the art. By way of illustration, typical storefront software 112 comprises product display components, product inventory components, ordering components, shopping cart components, and purchase order and purchase receipt generation components. A purchase receipt typically comprises information about the goods or services purchased, shipping information, billing information, and the price to be paid. The storefront software 112 also generates a transaction number for each transaction. According to embodiments of the present invention, the merchant transaction software 110 generates a bookmark index comprising a random value within a pre-established range for each transaction and captures the transaction number and purchase receipt information from the storefront software 112. The merchant computer 105 stores any purchase information in a purchase information database 116. Purchase information is any information other than the user's credit card number, such as the user's shipping address, which does not violate the user's privacy when transmitted over a network in an unsecured form.

User computer 120 of the present invention comprises user software 125. According to embodiments of the present invention, a user registers with user software 125. During the user registration with the user software 125, transaction information and one or more authentication datasets of personal identifying information of the user is stored on the user computer 105. The transaction information and personal identifying information are associated with a biometric identifier (e.g., a fingerprint, voiceprint, retinal scan, or other such identifier) supplied by the user. Subsequent access to the user transaction information and the personal identifying information requires presentment of the biometric identifier associated with that information. The user computer 120 further comprises a user database 124, a bio-identification device 126, and a communications log database 128. The user database 124 comprises a user's transaction information and one or more authentication datasets of personal identifying information.

By way of illustration and not as a limitation, transaction information comprises credit card numbers, authorized user names, a billing address, a shipping address, a biometric identifier and other information required in a commercial transaction. An authentication dataset of personal identifying information comprises data elements that have no intrinsic value to a third party (other than the clearinghouse) should the personal identifying information be intercepted. By way of illustration and not as a limitation, a first authentication dataset comprises the user's first name, a street address, a first key word and the last four digits of a bank account number.

A second authentication methodology comprises the user's last name, a street address, a second key work, and the last four digits of a credit card number. A bio-identification device 126 is connected to the user computer 120 and is used to obtain the biometric identifier from the user and to subsequently identify the user (described in detail below). Bio-identification data is stored in the user database 124. Biometric identifier devices use a biological trait of a person to identify them as a party to on-line activities. A common such device on the market today is the fingerprint identifier. Fingerprint identifiers, compatible with a personal computer, are available from technology manufacturers such as Link-It Technologies, or Cross-Match Technologies. Although a fingerprint identifier is preferred, it is not meant as a limitation. Other bio-identification systems can be used, including but not limited to retinal scanners, voice recognition systems, and palm print systems. The user computer 120 further includes a communications log database 128 for recording all transmissions made from the user computer 120 for on-line transactions. If there are any transaction discrepancies, the communications log database 128 is used to determine what occurred between parties to a transaction.

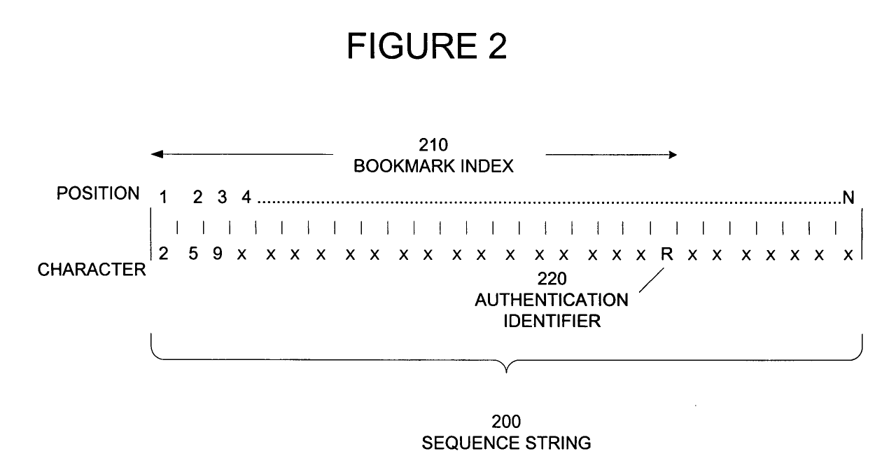

The user software 125 is adapted to generate a sequence string and to select an authentication identifier representing one of the available authentication datasets. FIG. 2 illustrates a format of a sequence string according to embodiments of the present invention. Referring to FIG. 2, a sequence string 200 of “N” locations each of which has a randomly generated value. A bookmark index 210 comprises a location within the length of the sequence string 200 where an authentication identifier 220 is inserted. The authentication identifier 220 is a value representing an authentication methodology randomly selected from a library of such methodologies. An authentication methodology is associated with a unique authentication data set of personal identifying information. Because both the user computer and the clearinghouse computer “know” the bookmark index, and because the user/recipient's authentication datasets of personal identifying information are stored on the user/receiving computer and the clearinghouse server, the sequence string represents a vehicle by which both devices can determine which authentication methodology is being used and can select the authentication dataset of personal identifying information to which the authentication methodology is to be applied. In this way, the requisite authentication dataset of personal identifying information can be delivered by the user computer and confirmed by the clearinghouse computer. By way of example, a sequence string 200 comprises “N=100” locations. A bookmark index 210 is randomly generated and has a value of “55”. An authentication methodology is selected having an authentication identifier 220 with a value of “16”. The value 16 is entered at location 55 of the sequence string “N=100.” Values at other locations within the sequence string are generated randomly.

Referring again to FIG. 1, the user software 125 inserts the authentication into the sequence string at a location determined by the bookmark index. The user's computer 120 then sends the transaction number and the purchase receipt received from the merchant, the sequence string generated by the user software 125, and the authentication dataset represented by the authentication identifier to the clearinghouse computer 140.

The clearinghouse computer 140 includes a user information database 142, a merchant database 144, and a communications log database 146. The user information database 142 stores user information files for each user registered with the clearinghouse computer 140. The user information files comprise transaction information and one or more authentication datasets of personal identifying information.

The merchant database 144 contains all participating merchant information obtain from merchants during merchant registration as well as transaction protocols preferred by each merchant. The communications log database 146 records all transmissions made from each merchant computer 105 and each user computer 120. The clearinghouse computer 140 also comprises clearinghouse software 145 for receiving the transaction information from the user computer 120. The user information database 142 contains a user's transaction information and one or more authentication datasets of personal identifying information. The authentication datasets stored in the customer identification database 142 on the clearinghouse computer 140 are the same authentication datasets as stored in the user database 124 on the user computer 120. The clearinghouse software 145 uses the bookmark index sent by the merchant to locate the authentication ID in the sequence string to determine which authentication dataset to apply to the user data sent by the user computer 120. (See, FIG. 2.)

The system of the present invention comprises a data transaction computer 150. The data transaction computer 150 tracks information for the system administrator. The data transaction computer 150 comprises a registered customer database 152 and an approved transactions database 154. The registered customer database 152 stores a customer identifier for each user of the purchase service. The approved transactions database 154 stores the transaction number of all transactions placed by registered users and approved by a clearinghouse computer 140 used by the purchasing service. Although disclosed as separate devices, the data transaction computer 150 can also be incorporated into the clearinghouse computer 140.

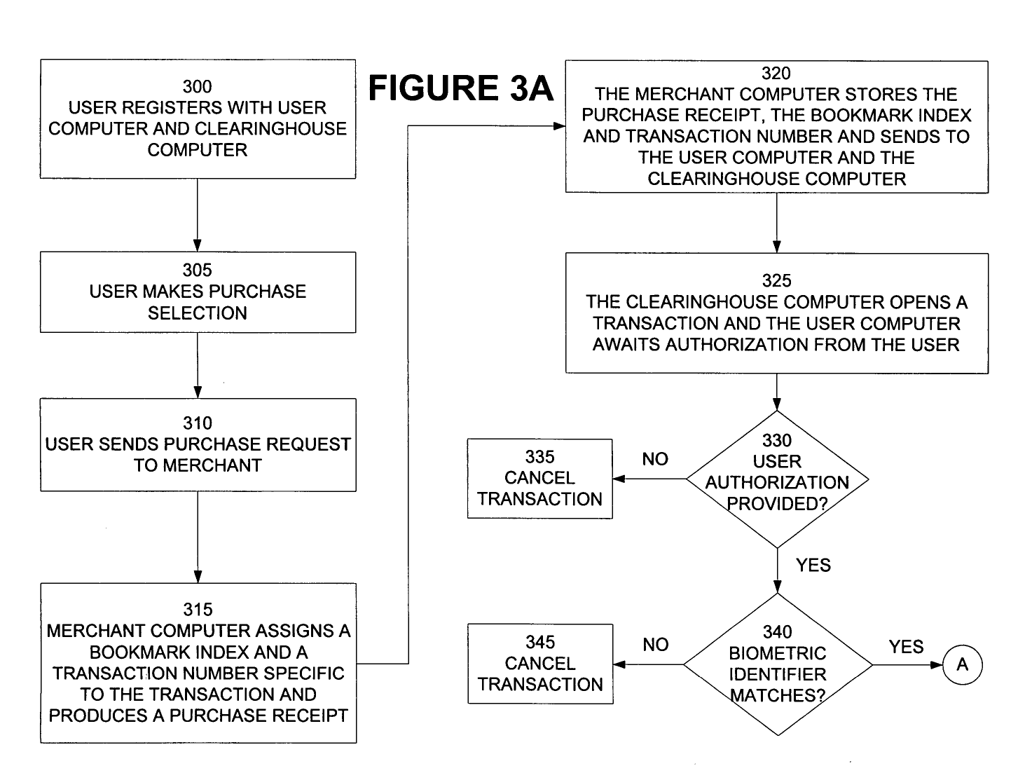

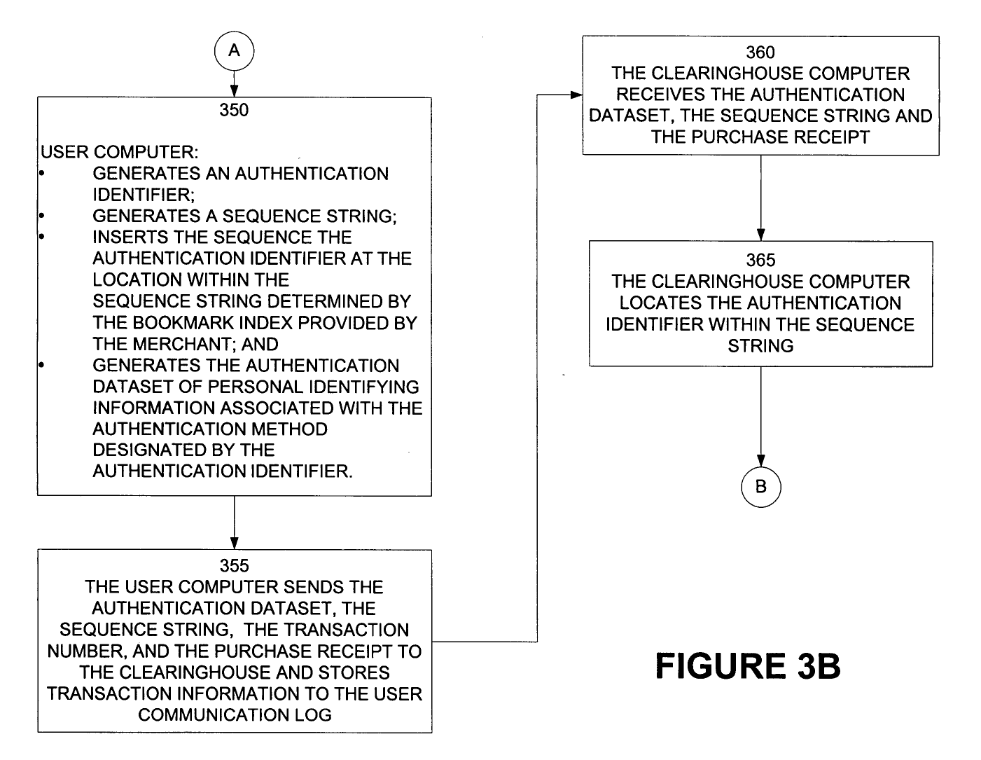

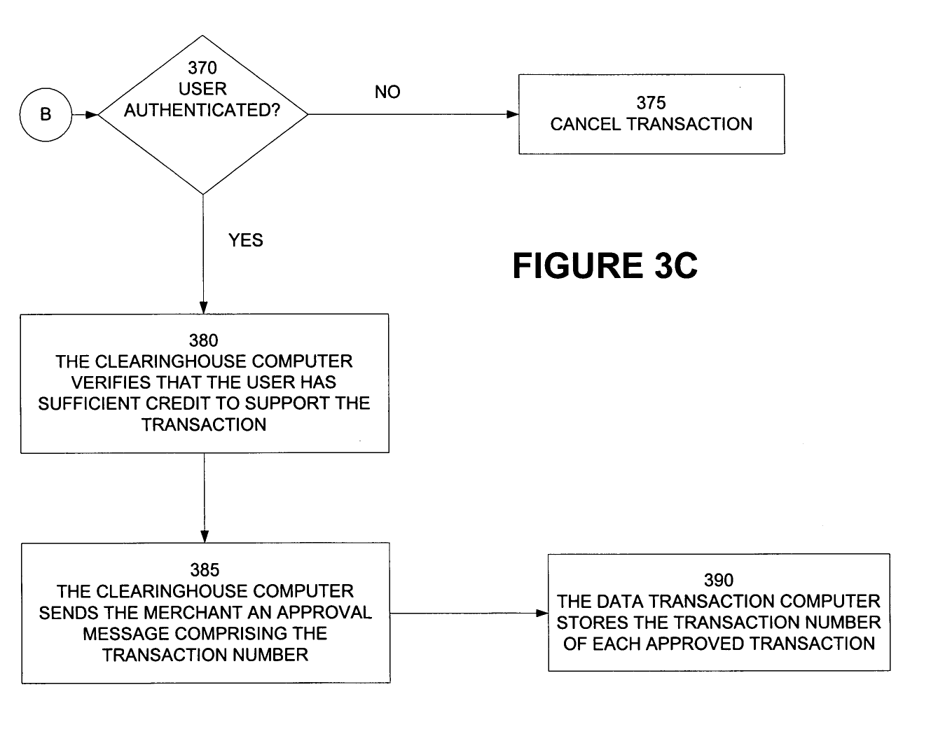

FIGS. 3A, 3B and 3C illustrate a method for purchasing goods via a network according to embodiments of the present invention. Referring to FIG. 3A, a user registers with user software operated by a user computer and with clearinghouse software operated by a clearinghouse computer 300. During registration, the user provides the user software with transaction information and one or more authentication datasets of personal identifying information. By way of illustration and not as a limitation, transaction information comprises credit card numbers, authorized user names, a billing address, a shipping address, a biometric identifier and other information required in a commercial transaction. This information remains resident on the user computer. An authentication dataset of personal identifying information comprises data elements that have no intrinsic value to a third party (other than the clearinghouse) should the personal identifying information be intercepted. By way of illustration and not as a limitation, a first authentication dataset comprises the user's first name, a street address, a first key word and the last four digits of a bank account number. A second authentication methodology comprises the user's last name, a street address, a second key word, and the last four digits of a credit card number. A biometric identifier is provided using a bio-identification device. By way of illustration and not as a limitation, where the biometric identifier is a fingerprint, the user will place his or her finger on the scanner connected to the user computer. The fingerprint is then compared to the stored fingerprint in the customer database. If a favorable comparison is made, the user is allowed to continue with the transaction. Without the authentication, the user computer will not forward any information to the clearinghouse computer. Using this authentication process is particularly advantageous to the user, the merchant and the clearinghouse operator for preventing credit card fraud. No transaction will take place without the proper authentication. Additionally, any thief attempting to access a user computer would need to leave behind a fingerprint, and is thus deterred from attempting to use the user computer to consummate a fraudulent transaction. To be successful, a thief could register with a clearinghouse using stolen financial instruments. In this case, the thief would also necessarily bind those instruments to his or her fingerprint at the thief's user computer. This evidentiary trail will also deter those attempting to defraud the payment system.

Referring again to FIG. 3, the user also submits transaction information and the one or more authentication datasets to the clearinghouse computer 300. The user software uses a secure transmission medium for sending the personal identifying information to the clearinghouse computer. Further, associating the user with a credit card number only happens during one on-line transmission instead of happening every time the user makes an on-line transaction. This significantly reduces the amount of times a user's information is susceptible to interception and in a form that is meaningful to the intercepting party. In order to increase security, the user may provide the registration information to the clearinghouse computer by United States mail. The user's information is then entered into the registration database via computer internal to the clearinghouse network. In this respect, the user is never associated with a credit card number during an on-line transmission of information. Further, the user's credit card information is never provided to the merchant. In this fashion, the user's credit card number cannot be stolen by any unauthorized access of the merchant computer.

From this point onward, only the user whose biometric identifier has been associated with the personal information can access that information to consummate a transaction. Subsequent to registering, the user desires to place an on-line transaction. The user selects items via a shopping cart web page maintained by the merchant 305. When the user has compiled his list of desired items, the user causes the user computer to transmit a request for purchase to the merchant 310. The request for purchase includes an indication that the user desires to use the system of the present invention. The user indicates using the system by selecting an icon. The icon can be present on the user's computer, the merchant's web page, or both. The request for purchase also includes transmitting the user's shipping address, either by completing a form presented to the user by the user storefront software (see FIG. 1, 112) or from the user database (see FIG. 1, 124). This allows the merchant to calculate appropriate shipping costs for the order.

The merchant computer assigns a bookmark index and a transaction number specific to the transaction and produces a purchase receipt 315. The bookmark index is a randomly generated value designating a location for the authentication identifier. The merchant computer stores the bookmark index, the transaction number and the purchase receipt in a purchase information database and sends the bookmark index and the transaction number to the user computer and the clearinghouse computer 320. In an alternate embodiment, the merchant computer does not send the purchase receipt to the clearinghouse computer. The clearinghouse computer receives the transaction number from the merchant computer and the user computer. The clearinghouse computer relies on the purchase receipt received from the user computer to determine how much is owed the merchant. According to this embodiment of the present invention, the user fully controls the transaction. Significantly, in either case, the merchant is not negotiating a transaction with the clearinghouse on behalf of the user. Rather, it is user who provides the clearinghouse the information necessary to consummate the purchase.

Upon receiving the bookmark index and transaction number, the clearinghouse computer opens a transaction and the user computer awaits authorization from the user 325. To authorize the transaction, all the user computer requires is the biometric identifier of the user that was associated with the transaction information and authorization datasets of the user. If the user does not provide authorization of the transaction 330, the transaction is not completed and the clearinghouse computer discards the transaction 335. If the user provides a biometric identifier, the user software determines if the proffered biometric identifier matches the stored resident biometric identifier 340. If the proffered biometric identifier and the stored resident identifier do not match, the transaction fails 345 and the clearinghouse computer discards the transaction.

Referring to FIG. 3B, if the proffered biometric identifier and the stored biometric identifier match, the user software operating on the user computer (350):

captures the bookmark index sent by the merchant;

selects an authentication identifier representing one of the available authentication datasets;

generates a sequence string;

inserts the authentication identifier at the location within the sequence string determined by the bookmark index provided by the merchant; and

generates the authentication dataset of personal identifying information associated with the authentication method designated by the authentication identifier.

The user computer sends the authentication dataset, the sequence string, the purchase receipt and the transaction number to clearinghouse and stores transaction information to the user communication log 355.

The clearinghouse computer receives the authentication dataset, the sequence string, the purchase receipt and the transaction number 360. The clearinghouse computer then locates the authentication identifier within the sequence string 365. Referring to FIG. 3C, the clearinghouse computer executes the authentication methodology associated with the authentication identifier using the authentication dataset of personal identifying information sent by the user 370. If the application of the authentication methodology to the authentication dataset fails, the transaction is cancelled 375. If the application of the authentication methodology to the authentication dataset is successful, the clearinghouse computer verifies that the user has sufficient credit to support the transaction 380. The clearinghouse computer sends the merchant an approval message comprising the transaction number 385 and an amount to be credited to the merchant's account. Thus, the transaction has been entered, yet no personal identification of the user, particularly being associated with a credit card number, has ever been transmitted to the merchant. The data transaction computer stores the transaction number of each approved transaction 390.

According to an embodiment of the present invention, a system provider is paid according to the number of transactions placed. Since the clearinghouse has authority to charge a user's credit card, a transaction charge may be assessed to the user of the system. In an alternate embodiment, a merchant pays the clearinghouse for each transaction processed on behalf of the merchant. For example, a front-end credit card processor may operate the clearinghouse and the transaction charges incorporated into the charges levied to a merchant for processing credit card transactions on that merchant's behalf. Similarly, any other terms of service agreed to between the parties could be used.

In another embodiment, a user registration number is incorporated into the transaction communication sent by the user computer to the clearinghouse computer. The registration number is associated with a user address, such as an e-mail address, which the clearinghouse computer uses to provide off-line communications with the user. For example, the clearinghouse may notify the user of special promotions, user software or other services of interest to the user.

The user enjoys particular security in knowing that the transaction occurs without any transmission of information, which can identify the user if intercepted. Further, the user's trust when placing on-line transactions is developed without any cost to the merchant. The security encourages users to buy more frequently in two respects. First, purchases occur more quickly because the user does not need to repeatedly enter identification information. Thus, the user can buy more and is more likely to purchase impulsively. The user also becomes comfortable with placing on-line transactions because all the transactions occur in the same manner regardless of the merchant used.

The merchant and credit card companies also benefits from the increased transactions. Both see larger sales volume without expense. Further, the merchant and the credit card company actually have reduced manpower, service, and system use because the system provider reduces the information processing burden.

An additional benefit is realized for users because the biometric identifier information is stored in the user database 124 (shown in FIG. 1). This information may serve to aid law enforcement in identifying missing children or other persons if the user allows the information to be divulged for these purposes.

Although the system and method of the present invention has been described with several information fields transmitted at one time, it will be appreciated by those skilled in the art that information fields may be transmitted separately.

In an embodiment of the present invention, a system for conducting on-line transactions with enhanced security over a network comprises a user computer, a clearinghouse computer, a data transaction computer and a merchant computer, all linked to a network. The user computer comprises a biometric identifier peripheral, a processor and memory, a biometric identifier of a user is stored in the user computer memory. The user computer further comprises logic for permitting the user to enter a biometric identifier into the user computer using the biometric identifier peripheral, for comparing the entered biometric identifier with the stored biometric identifier and for requesting the clearinghouse computer to enter a transaction only if the entered biometric identifier is the same as the stored biometric identifier.

In another embodiment of the present invention, a system for providing enhanced security for on-line transactions conducted over a network comprises a user computer, a clearinghouse computer, a data transaction computer and a merchant computer, all linked to a network. The user computer has a processor and a memory and further comprises a bioscaner, a customer database comprising customer data stored in the user computer memory, a plurality of encryption logic stored in the user computer memory and instructions for randomly selecting one of the plurality of encryption logics and for encrypting transaction information according to the randomly selected encryption logic, and instructions for creating data pointers from the customer data. The clearinghouse computer has a processor and a memory and comprises a customer database stored in the clearinghouse computer memory, a merchant database stored in the clearinghouse computer memory, and a communications log database stored in the clearinghouse computer memory. The clearinghouse computer further comprises instructions for encrypting and decrypting transaction information according to the randomly selected encryption logic assigned by the user computer. When the user sends a transaction request to the merchant computer over the network, the merchant computer generates a bookmark index and sequence string. The merchant computer transmits the bookmark index and sequence string to the user computer over the network and the user computer generates an encryption key and encodes the transaction information, according to the randomly selected encryption logic.

In still another embodiment of the present invention, a method of providing enhanced security for an on-line transaction is provided. A user sends a transaction request from a user computer to a merchant computer. The merchant computer generates a bookmark index and sequence string for the transaction at the merchant computer and transmits the bookmark index and sequence string to the user computer. The user computer randomly selects an encryption method and places an ID for the selected encryption method in the sequence string at the user computer. The user computer transmits the bookmark index, sequence string, and the ID, to a clearinghouse computer. A user biometric identifier is entered at the user computer requesting the transaction. The biometric identifier of the user is compared to a customer database of authorized user biometric identifiers stored in the user computer. If the biometric identifier of a person requesting the purchase matches the authorized user biometric identifiers stored in the user computer, an authorization to proceed is sent from the user computer to the clearinghouse computer. A set of data pointers is selected from the customer database stored in the user computer and transmitted to the clearinghouse computer. At the clearinghouse computer, the approval of the transaction by an authorized user is verified as is the sufficiency of the credit of the user to support the transaction. The merchant is notified that the transaction is approved.

In another embodiment of the present invention, a method for authenticating a participant in a transaction conducted over a network is provided. The method comprises proffering a biometric identifier of the participant to a sending computer and making a determination whether the proffered biometric identifier matches a biometric identifier resident on the sending computer. In the event the proffered biometric identifier matches the resident biometric identifier, the participant is granted access to the sending computer. Encrypted participant data and a sequence string is received from the sending computer. A decryption methodology is determined from the sequence string and a set of fixed key data. The encrypted participant data is decrypted using the decryption methodology and the sequence string. A determination is made whether the participant data matches a participant profile. In another embodiment of the present invention, the sequence string comprises a string of random values having an encryption method identifier located at a position within the random number string. The fixed key data comprises an encryption method associated with the encryption method identifier and a bookmark index pointing to the location within the random number string where the encryption method identifier is located. Decrypting the encrypted participant data using the decryption methodology and the sequence string comprises applying the decryption methodology associated with the encryption method identifier to the encrypted participant data using the sequence string as a key.

In another embodiment of the present invention, a method for conducting on-line transactions with enhanced security over a network is provided. The method comprises sending a transaction request from a buyer computer to a merchant computer. Transaction data and a bookmark index are sent from the merchant to the buyer computer and a clearinghouse computer. A biometric identifier of the buyer is proffered to the buyer computer and a determination is made whether the proffered biometric identifier matches a biometric identifier resident on the buyer computer. In the event the proffered biometric identifier matches the resident biometric identifier, the buyer is granted access to the buyer computer. Encrypted transaction data, encrypted buyer data and a sequence string from the buyer computer are received at the clearinghouse computer. A decryption methodology is determined from the sequence string and the bookmark index. The encrypted buyer data is decrypted using the decryption methodology and the sequence string. A determinate is made whether the buyer data matches a buyer profile. If the buyer data matches the buyer profile, authorizing the transaction. In another embodiment of the present invention, the sequence string comprises a random number string having an encryption method identifier located at a position within the random number string. The fixed key data comprises an encryption method associated with the encryption method identifier and a bookmark index pointing to the location within the random number string where the encryption method identifier is located. Decrypting the encrypted participant data using the decryption methodology and the sequence string comprises applying the decryption methodology associated with the encryption method identifier to the encrypted participant data using the sequence string as a key.

In still another embodiment of the present invention, a system for authenticating a participant in a transaction conducted over a network comprises a sending computer and a clearinghouse computer each connected to the network. The sending computer comprises a resident biometric identifier and is adapted to receive a proffered biometric identifier from the participant, make a determination whether the proffered biometric identifier matches the resident biometric identifier, in the event the proffered biometric identifier matches the resident biometric identifier, grant the participant access to the sending computer; and send to the clearinghouse computer encrypted participant data and a sequence string. The clearinghouse computer comprises a participant profile and a set of fixed key data and is adapted to receive from the sending computer encrypted participant data and the sequence string, determine a decryption methodology from the sequence string and the set of fixed key data, decrypt the encrypted participant data using the decryption methodology and the sequence string; and determine whether the participant data matches a participant profile. In another embodiment of the present invention, the sequence string comprises a random number string having an encryption method identifier located at a position within the random number string. The fixed key data comprises an encryption method associated with the encryption method identifier and a bookmark index pointing to the location within the random number string where the encryption method identifier is located. The encrypted participant data is decrypted using the decryption methodology and the sequence string by applying the decryption methodology associated with the encryption method identifier to the encrypted participant data using the sequence string as a key.

In yet another embodiment of the present invention, a system for conducting on-line transactions with enhanced security over a network comprises a buyer computer, a merchant computer and a clearinghouse computer each connected to the network. The merchant computer is adapted to receive from the buyer computer a transaction request, if the transaction request is accepted, create transaction data and a bookmark index; and send the transaction data to the buyer computer and the bookmark index to the buyer computer and the clearinghouse computer. The buyer computer comprises a resident biometric identifier and is adapted to send a transaction request to the merchant computer, receive from the merchant computer transaction data and a bookmark index, receive a proffered biometric identifier from the buyer, make a determination whether the proffered biometric identifier matches the resident biometric identifier. In the event the proffered biometric identifier matches the resident biometric identifier, the buyer computer is adapted to grant the buyer access to the sending computer and to send to the clearinghouse computer encrypted buyer data and a sequence string. The clearinghouse computer comprises a buyer profile and a set of fixed key data and is adapted to receive from the merchant computer the bookmark index, receive from the sending computer encrypted buyer data and the sequence string, determine a decryption methodology from the sequence string and the bookmark index, decrypt the encrypted buyer data using the decryption methodology and the sequence string; and determine whether the buyer data matches a buyer profile. If the buyer data matches the buyer profile, the clearinghouse computer is adapted to authorize the transaction. In another embodiment of the present invention, the sequence string comprises a random number string having an encryption method identifier located at a position within the random number string. The fixed key data comprises an encryption method associated with the encryption method identifier and a bookmark index pointing to the location within the random number string where the encryption method identifier is located. The encrypted participant data is decrypted using the decryption methodology and the sequence string by applying the decryption methodology associated with the encryption method identifier to the encrypted participant data using the sequence string as a key.

A system and method of user-controlled on-line transactions has been described. It will be understood by those skilled in the art that a wide variety of web-enabled devices adapted for use with biometric identifiers, such as mobile phones, PDA's, or web phones with a biometric identifier means, may be used without departing from the scope of present invention as disclosed. It will be further understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A method for authorizing a purchase transaction between a merchant and a purchaser over a network comprising:
from a user computer, sending a purchase request to a merchant computer;
from the merchant computer, sending transaction data and an identifier indicative of an authentication methodology to the user computer and a clearinghouse computer;
proffering a biometric identifier to the user computer, wherein the user computer determines whether the proffered biometric identifier and a stored biometric identifier match;
in the event the proffered biometric identifier and the stored biometric identifier match, at the user computer sending an authentication dataset of purchaser identifying information associated with the authentication identifier and transaction information to the clearinghouse computer; and
at the clearinghouse computer, applying the authentication methodology associated with the authentication identifier to the authentication dataset of purchaser identifying information received from the user computer and to an authentication dataset of purchaser identifying information stored on the clearinghouse computer to authenticate the purchaser;
whereupon successful authentication of the purchaser, the transaction is authorized by the clearinghouse without any purchaser registration data being provided to the merchant.

2. The method for authorizing a purchase transaction between a merchant and a purchaser over a network of claim 1, wherein the method further comprises:
storing on a user computer purchaser transaction information and a plurality of authentication datasets of purchaser identifying information (herein collectively, “purchaser registration data”), wherein each authentication dataset is associated with a unique authentication methodology;
uniquely associating the purchaser with the purchaser registration data stored on the user computer using a biometric identifier obtained from the purchaser and stored solely on the user computer; and
storing the purchaser registration data on a clearinghouse computer.

3. The method for authorizing a purchase transaction between a merchant and a purchaser over a network of claim 1, wherein the network is the Internet.

4. The method for authorizing a purchase transaction between a merchant and a purchaser over a network of claim 1, wherein the network is a wireless network.

5. The method for authorizing a purchase transaction between a merchant and a purchaser over a network of claim 1, wherein the network is an intranet.

6. The method for authorizing a purchase transaction between a merchant and a purchaser over a network of claim 1, wherein proffering a biometric identifier to the user computer comprises proffering a fingerprint scan.

7. The method for authorizing a purchase transaction between a merchant and a purchaser over a network of claim 1, wherein proffering a biometric identifier to the user computer comprises proffering a face print scan.

8. The method for authorizing a purchase transaction between a merchant and a purchaser over a network of claim 1, wherein proffering a biometric identifier to the user computer comprises proffering a retinal scan.

9. The method for authorizing a purchase transaction between a merchant and a purchaser over a network of claim 1, wherein proffering a biometric identifier to the user computer comprises proffering a palm print scan.

10. The method for authorizing a purchase transaction between a merchant and a purchaser over a network of claim 1, wherein proffering a biometric identifier to the user computer comprises proffering a voice print scan.

11. The method for authorizing a purchase transaction between a merchant and a purchaser over a network of claim 1, wherein the transaction is a purchase of goods or services.

12. The method for authorizing a purchase transaction between a merchant and a purchaser over a network of claim 1, wherein the transaction is an access and distribution of information.

13. A method for authorizing a purchase transaction between a merchant and a purchaser over a network comprising:
storing on a user computer purchaser transaction information and a plurality of authentication datasets of purchaser identifying information (herein collectively, “purchaser registration data”), wherein each authentication dataset is associated with a unique authentication methodology;
uniquely associating the purchaser with the purchaser registration data stored on the user computer using a biometric identifier obtained from the purchaser and stored solely on the user computer;
storing the purchaser registration data on a clearinghouse computer;
from the user computer, sending a request to purchase to the merchant computer;
from the merchant computer, sending a bookmark index, a purchase transaction number specific to the transaction, and a purchase receipt to the user computer and sending the bookmark index the transaction number to the clearinghouse computer;
proffering a biometric identifier to the user computer, wherein the user computer determines whether the proffered biometric identifier and the stored biometric identifier match;
in the event the proffered biometric identifier and the stored biometric identifier match, at the user computer:
generating an authentication identifier, wherein the authentication identifier is associated with a unique authentication methodology;
generating a sequence string;
inserting the authentication identifier at a location within the sequence string determined by the bookmark index;
generating the particular one of the plurality of authentication datasets associated with the unique authentication method designated by the authentication identifier; and
sending the sequence string, the particular one of the plurality of authentication datasets, the transaction number and the purchase receipt to the clearinghouse computer;
at the clearinghouse computer,
locating the authentication identifier in the sequence string using the bookmark index received from the merchant;
applying the unique authentication methodology associated with the authentication identifier to the particular one of the plurality of authentication datasets received from the user computer to authenticate the purchaser; and
in the event the application of the unique authentication methodology associated with the authentication identifier to the particular one of the plurality of authentication datasets is successful, authorizing the transaction without any purchaser registration data being provided to the merchant and without the use of complex mathematical encryption algorithms.

14. The method for authorizing a purchase transaction between a merchant and a purchaser over a network of claim 13, wherein the network is the Internet.

15. The method for authorizing a purchase transaction between a merchant and a purchaser over a network of claim 13, wherein the network is a wireless network.

16. The method for authorizing a purchase transaction between a merchant and a purchaser over a network of claim 13, wherein the network is an intranet.

17. The method for authorizing a purchase transaction between a merchant and a purchaser over a network of claim 13, wherein:
uniquely associating the purchaser with the purchaser registration data stored on the user computer using a biometric identifier obtained from the purchaser comprises uniquely associating the purchaser with the purchaser registration data stored on the user computer using a fingerprint scan obtained from the purchaser; and
proffering a biometric identifier to the user computer comprises proffering a fingerprint scan.

18. The method for authorizing a purchase transaction between a merchant and a purchaser over a network of claim 13, wherein:
uniquely associating the purchaser with the purchaser registration data stored on the user computer using a biometric identifier obtained from the purchaser comprises uniquely associating the purchaser with the purchaser registration data stored on the user computer using a face print scan obtained from the purchaser; and
proffering a biometric identifier to the user computer comprises proffering a face print scan.

19. The method for authorizing a purchase transaction between a merchant and a purchaser over a network of claim 13, wherein:
uniquely associating the purchaser with the purchaser registration data stored on the user computer using a biometric identifier obtained from the purchaser comprises uniquely associating the purchaser with the purchaser registration data stored on the user computer using a retinal scan obtained from the purchaser; and
proffering a biometric identifier to the user computer comprises proffering a retinal scan.

20. The method for authorizing a purchase transaction between a merchant and a purchaser over a network of claim 13, wherein:
uniquely associating the purchaser with the purchaser registration data stored on the user computer using a biometric identifier obtained from the purchaser comprises uniquely associating the purchaser with the purchaser registration data stored on the user computer using a palm print scan obtained from the purchaser; and
proffering a biometric identifier to the user computer comprises proffering a palm print scan.

21. The method for authorizing a purchase transaction between a merchant and a purchaser over a network of claim 13, wherein:
uniquely associating the purchaser with the purchaser registration data stored on the user computer using a biometric identifier obtained from the purchaser comprises uniquely associating the purchaser with the purchaser registration data stored on the user computer using a voice print scan obtained from the purchaser; and
proffering a biometric identifier to the user computer comprises proffering a voice print scan.

22. The method for authorizing a purchase transaction between a merchant and a purchaser over a network of claim 13, wherein the transaction is a purchase of goods or services.

23. The method for authorizing a purchase transaction between a merchant and a purchaser over a network of claim 13, wherein the transaction is an access and distribution of information.

24. A system for conducting a purchase transaction over a network, the system comprising a buyer computer, a merchant computer and a clearinghouse computer each connected to the network, and wherein:
the merchant computer is adapted to:
receive from the buyer computer a purchase transaction request;
create a bookmark index, a purchase transaction number specific to the transaction, and a purchase receipt; and
send the bookmark index, the purchase transaction number specific to the transaction, and the purchase receipt to the user computer and send the bookmark index the transaction number to the clearinghouse computer; and
the buyer computer comprises a resident biometric identifier, computer purchaser transaction information and a plurality of authentication datasets of purchaser identifying information (herein collectively, “purchaser registration data”), wherein each authentication dataset is associated with a unique authentication methodology and wherein the buyer computer is adapted to:
send a purchase transaction request to the merchant computer;
receive from the merchant computer bookmark index, the purchase transaction number specific to the transaction, and the purchase receipt;
receive a proffered biometric identifier from the buyer;
make a determination whether the proffered biometric identifier matches the resident biometric identifier;
in the event the proffered biometric identifier matches the resident biometric identifier—
generate an authentication identifier, wherein the authentication identifier is associated with a unique authentication methodology;
generate a sequence string;
insert the authentication identifier at a location within the sequence string determined by the bookmark index;
generate the particular one of the plurality of authentication datasets associated with the unique authentication method designated by the authentication identifier; and
send the sequence string, the particular one of the plurality of authentication datasets, the transaction number and the purchase receipt to the clearinghouse computer; and
the clearinghouse computer comprises purchaser registration data and is adapted to:
locate the authentication identifier in the sequence string using the bookmark index received from the merchant; and
apply the unique authentication methodology associated with the authentication identifier to the particular one of the plurality of authentication datasets received from the user computer to authenticate the purchaser; and
in the event the application of the unique authentication methodology associated with the authentication identifier to the particular one of the plurality of authentication datasets is successful, authorize the transaction without any purchaser registration data being provided to the merchant.

25. The system of claim 24, wherein the network is the Internet.

26. The system of claim 24, wherein the network is a wireless network.

27. The system of claim 24, wherein the network is an intranet.

28. The system of claim 24, wherein the biometric identifier is a fingerprint scan.

29. The system of claim 24, wherein the biometric identifier is a face print scan.

30. The system for conducting on-line transactions with enhanced security over a network of claim 24, wherein the biometric identifier is a retinal scan.

31. The system of claim 24, wherein the biometric identifier is a palm print scan.

32. The system of claim 24, wherein the biometric identifier is a voice print scan.

33. The system of claim 24, wherein the transaction is a purchase of goods or services.

34. The system of claim 24, wherein the transaction is an access and distribution of information.

35. A method for authenticating a participant in a transaction conducted over a network, the method comprising:
generating a bookmark index at the computer of a first participant and sending the bookmark index to a clearinghouse computer and the computer of a second participant; and
at the computer of the second participant:
generating an authentication identifier, wherein the authentication identifier is associated with a unique authentication methodology;
generating a sequence string;
inserting the authentication identifier at a location within the sequence string determined by the bookmark index;
generating the particular one of the plurality of authentication datasets associated with the unique authentication method designated by the authentication identifier; and
sending the sequence string and the particular one of the plurality of authentication datasets to the clearinghouse computer.

36. A method for authenticating a participant in a transaction conducted over a network, the method comprising:
receiving at a clearinghouse computer a bookmark index from a first participant and a sequence string from a second participant;
locating an authentication identifier in the sequence string using the bookmark index received from the first participant; and
applying an authentication methodology associated with the authentication identifier to a particular one of the plurality of authentication datasets associated with the second participant;
in the event the application of the unique authentication methodology associated with the authentication identifier to the particular one of the plurality of authentication datasets is successful, authenticating the second participant.
